(19) United States
(12) Patent Application Publication
(10) Pub. No.: US 2024/0367603 A1
(43) Pub. Date: Nov. 7, 2024

(54) PHYSIQUE ESTIMATION DEVICE AND PHYSIQUE ESTIMATION METHOD

(71) Applicant: Mitsubishi Electric Corporation, Tokyo (JP)

(72) Inventors: Hirotaka SAKAMOTO, Tokyo (JP); Yuki FURUMOTO, Tokyo (JP); Naoya BABA, Tokyo (JP); Shohei TAKAHARA, Tokyo (JP)

(73) Assignee: Mitsubishi Electric Corporation, Tokyo (JP)

(21) Appl. No.: 18/574,322

(22) PCT Filed: Jul. 9, 2021
(86) PCT No.: PCT/JP2021/025969

§ 371 Date: Dec. 27, 2023

(51) Int. Cl. B60R 21/015; B60N 2/02

(52) U.S. Cl. CPC B60R 21/01552; B60N 2/02; B60R 21/01538

(57) ABSTRACT

Processing circuitry acquires a captured image in which an occupant of a vehicle is captured having an optical axis parallel to a moving direction of a seat movable back and forth, detects skeleton coordinate points of the occupant on the basis of the captured image, calculates, on the basis of the skeleton coordinate points, a correction amount on the basis of a ratio between a first distance that is a horizontal distance from a straight line passing through a center of and parallel to a longitudinal direction of the captured image to a correction amount calculating skeleton coordinate point and a second distance that is a horizontal distance from the straight line to a reference coordinate point on the captured image corresponding to the correction amount calculating skeleton coordinate point, and estimates a physique of the occupant on the basis of the skeleton coordinate points and the correction amount.

### TECHNICAL FIELD

The present disclosure relates to a physique estimation device and a physique estimation method for an occupant of a vehicle.

### BACKGROUND ART

Conventionally, a technique for estimating a physique of an occupant in a vehicle on the basis of a captured image obtained by capturing an image of the occupant is known (for example, Patent Literature 1).

### CITATION LIST

### Patent Literature

Patent Literature 1: JP 2020-104680 A

### SUMMARY OF INVENTION

### Technical Problem

In a vehicle, a seat on which an occupant is seated can be moved back and forth with respect to a traveling direction of the vehicle. When the seat is moved back and forth, the occupant is captured in a large size or in a small size on a captured image along with the movement.

In a conventional technique as described in Patent Literature 1, an inclination of a posture of an occupant is considered, but it is not considered that the occupant is captured in a large size or in a small size on a captured image as the seat is moved back and forth. Therefore, in the conventional technique, there is a problem that a physique of an occupant may be erroneously estimated when a seat on which the occupant is seated is moved back and forth.

Note that Patent Literature 1 describes that detection accuracy of the physique of an occupant decreases when a change in a state of a seat (for example, sliding or reclining) occurs. However, Patent Literature 1 does not disclose a specific method for detecting a physique when a position of an occupant seated on a seat is also changed back and forth together with the seat as the seat is slid back and forth. Therefore, the technique as disclosed in Patent Literature 1 still cannot solve the above problem.

The present disclosure has been made in order to solve the above problem, and an object of the present disclosure is to provide a physique estimation device that improves accuracy of estimating a physique of an occupant of a vehicle when a seat on which the occupant is seated is moved back and forth with respect to a traveling direction of the vehicle.

### Solution to Problem

A physique estimation device according to the present disclosure includes: a captured image acquiring unit to acquire a captured image in which an occupant of a vehicle is captured by an imaging device having an optical axis parallel to a moving direction of a seat of the vehicle, the seat being movable back and forth with respect to a traveling direction of the vehicle; a skeleton point detecting unit to detect a plurality of skeleton coordinate points of the occupant indicating parts of a body of the occupant on the captured image on a basis of the captured image acquired by the captured image acquiring unit; a correction amount calculating unit to calculate, on a basis of information regarding the plurality of skeleton coordinate points detected by the skeleton point detecting unit, a correction amount on a basis of a ratio between a first distance and a second distance, the first distance being a horizontal distance from a straight line passing through a center of the captured image acquired by the captured image acquiring unit and parallel to a longitudinal direction of the captured image to at least one correction amount calculating skeleton coordinate point among the plurality of skeleton coordinate points detected by the skeleton point detecting unit and the second distance being a horizontal distance from the straight line to a reference coordinate point on the captured image corresponding to the at least one correction amount calculating skeleton coordinate point, the reference coordinate point being set by assuming the at least one correction amount calculating skeleton coordinate point in a case where the seat is at a set reference position; and a physique estimation unit to estimate a physique of the occupant on a basis of the information regarding the plurality of skeleton coordinate points detected by the skeleton point detecting unit and the correction amount calculated by the correction amount calculating unit.

### Advantageous Effects of Invention

According to the present disclosure, it is possible to improve accuracy of estimating a physique of an occupant of a vehicle when a seat on which the occupant is seated is moved back and forth with respect to a traveling direction of the vehicle.

### BRIEF DESCRIPTION OF DRAWINGS

FIG. 1 is a diagram illustrating a configuration example of a physique estimation device according to a first embodiment.

FIG. 2 is a diagram illustrating an example of a captured image exemplifying a skeleton coordinate point and a reference coordinate point on an image in the first embodiment.

FIG. 3 is a diagram for describing an example of a method for calculating a correction amount by a correction amount calculating unit in the first embodiment.

FIG. 4 is a flowchart for describing an operation of the physique estimation device according to the first embodiment.

FIGS. 5A and 5B are each a diagram illustrating an example of a hardware configuration of the physique estimation device according to the first embodiment.

### DESCRIPTION OF EMBODIMENTS

Hereinafter, an embodiment of the present disclosure will be described in detail with reference to the drawings.

### First Embodiment

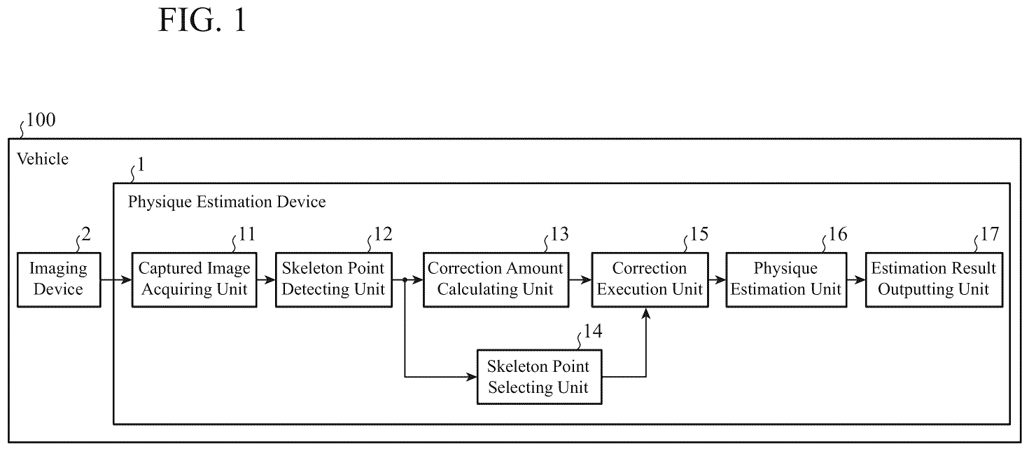

FIG. 1 is a diagram illustrating a configuration example of a physique estimation device 1 according to a first embodiment.

In the first embodiment, it is assumed that the physique estimation device 1 is mounted on a vehicle 100.

The physique estimation device 1 is connected to an imaging device 2 mounted on the vehicle 100.

The imaging device 2 is, for example, a near-infrared camera or a visible light camera, and captures an image of an occupant present in the vehicle 100. The imaging device 2 may be shared with, for example, a so-called “Driver Monitoring System (DMS)”.

The imaging device 2 is disposed in such a way as to be able to image at least a range in the vehicle 100 including a range in which an upper body of an occupant of the vehicle 100 is expected to be present. The range in which an upper body of an occupant in the vehicle 100 is expected to be present is, for example, a range corresponding a space near a front of a backrest of the seat and of a headrest.

In the first embodiment, as an example, it is assumed that the imaging device 2 is disposed at a center of the vehicle 100 in a vehicle width direction. Note that, in the first embodiment, the center in the vehicle width direction is not limited to a strict “center”, but includes a “substantial center”. Specifically, it is assumed that the imaging device 2 is disposed, for example, near a center console of the vehicle 100 or a dashboard center where a car navigation system or the like is disposed. The imaging device 2 captures an image of a driver and an occupant in an assistant driver's seat (hereinafter, referred to as an “assistant driver's seat occupant”).

In the first embodiment, it is assumed that an optical axis of the imaging device 2 is parallel to a guide rail for moving a seat of the vehicle 100 back and forth. That is, the imaging device 2 has an optical axis parallel to a moving direction of a seat of the vehicle 100 that is movable back and forth with respect to a traveling direction of the vehicle 100. In the first embodiment, being “parallel” between the optical axis of the imaging device 2 and the moving direction of the seat is not limited to being strictly “parallel”, but includes being “substantially parallel” within a set range.

Note that the position where the imaging device 2 is disposed as described above is merely an example. The imaging device 2 only needs to be disposed in such a way as to be able to image a range in which an upper body of an occupant of the vehicle 100 is expected to be present.

In addition, only one imaging device 2 is illustrated in FIG. 1, but this is merely an example. A plurality of the imaging devices 2 may be mounted on the vehicle 100, and the plurality of imaging devices 2 may be connected to the physique estimation device 1. For example, on the vehicle 100, two imaging devices 2, that is, an imaging device 2 that captures an image of an occupant in a driver's seat and an imaging device 2 that captures an image of an assistant driver's seat occupant may be mounted.

The physique estimation device 1 estimates a physique of an occupant of the vehicle 100 on the basis of a captured image in which the occupant of the vehicle 100 is captured by the imaging device 2. In the first embodiment, it is assumed that the occupants of the vehicle 100 are a driver and an assistant driver's seat occupant. That is, in the first embodiment, the physique estimation device 1 estimates physiques of the driver and the assistant driver's seat occupant on the basis of a captured image in which the driver and the assistant driver's seat occupant are captured by the imaging device 2.

In the first embodiment, the physique estimated by the physique estimation device 1 is any one of an “infant”, a “small man”, a “small woman”, a “standard man”, a “standard woman”, a “large man”, and a “large woman”. Note that this is merely an example, and a definition of the physique estimated by the physique estimation device 1 can be appropriately set.

When estimating the physique of the occupant of the vehicle 100, the physique estimation device 1 outputs a result of estimating the physique of the occupant of the vehicle 100 (hereinafter, referred to as a “physique estimation result”) to various devices connected to the physique estimation device 1. Examples of the various devices include an airbag control device (not illustrated), a notification device (not illustrated), and a display device (not illustrated).

For example, the airbag control device controls an airbag on the basis of the physique determining result output from the physique estimation device 1.

For example, the notification device outputs an alarm for urging wearing of a seat belt in consideration of the physique of the occupant on the basis of the physique estimation result output from the physique estimation device 1.

For example, the display device performs display corresponding to the physique estimation result output from the physique estimation device 1. For example, when there is an “infant” among the occupants, the display device displays an icon indicating that a child is in the vehicle.

The physique estimation device 1 includes a captured image acquiring unit 11, a skeleton point detecting unit 12, a correction amount calculating unit 13, a skeleton point selecting unit 14, a correction execution unit 15, a physique estimation unit 16, and an estimation result outputting unit 17.

The captured image acquiring unit 11 acquires a captured image in which an occupant of the vehicle 100 is captured by the imaging device 2.

The captured image acquiring unit 11 outputs the acquired captured image to the skeleton point detecting unit 12.

The skeleton point detecting unit 12 detects a skeleton coordinate point of the occupant indicating a part of a body of the occupant on the basis of the captured image acquired by a captured image acquiring unit 11. More specifically, the skeleton point detecting unit 12 detects a skeleton coordinate point of the occupant indicating a joint point determined for each part of a body of the occupant on the basis of the captured image acquired by the captured image acquiring unit 11. Specifically, the skeleton point detecting unit 12 detects coordinate values of the skeleton coordinate point of the occupant and which part of the body of the occupant the skeleton coordinate point indicates. The skeleton coordinate point is a point in the captured image, and is indicated by coordinate values in the captured image.

In the first embodiment, for example, a joint point of a nose, a joint point of a neck, a joint point of a shoulder (a right shoulder and a left shoulder), a joint point of an elbow (a right elbow and a left elbow), a joint point of a waist (a right waist and a left waist), a joint point of a wrist, a joint point of a knee, and a joint point of an ankle are defined as the joint point determined for each part of a human body. For paired parts of a body, specifically, for each of a shoulder, an elbow, a waist, a wrist, a knee, and an ankle, two left and right joint points are defined as joint points corresponding to the part of the body.

For example, the skeleton point detecting unit 12 detects the skeleton coordinate point of the occupant using a trained model in machine learning (hereinafter, referred to as a “first machine learning model”) that receives, as an input, a captured image in which the occupant of the vehicle 100 is captured and outputs information regarding the skeleton coordinate point in the captured image. The information indicating the skeleton coordinate point includes coordinate values of the skeleton coordinate point in the captured image and information capable of specifying which part of the body the skeleton coordinate point indicates. Note that this is merely an example, and the skeleton point detecting unit 12 only needs to detect the skeleton coordinate point of the occupant using various known image processing techniques.

The skeleton point detecting unit 12 does not necessarily detect all skeleton coordinate points indicating the defined joint points (joint points of a shoulder, an elbow, a waist, a wrist, a knee, and an ankle). It is possible to appropriately set a skeleton coordinate point indicating a joint point to be detected by the skeleton point detecting unit 12. In the first embodiment, as an example, the skeleton point detecting unit 12 detects a skeleton coordinate point indicating a nose of the occupant, a skeleton coordinate point indicating a neck of the occupant, a skeleton coordinate point indicating a shoulder of the occupant, and a skeleton coordinate point indicating an elbow of the occupant.

When detecting the skeleton coordinate point, the skeleton point detecting unit 12 can also detect which occupant's skeleton coordinate point the detected skeleton coordinate point is. Note that, in the first embodiment, the skeleton point detecting unit 12 determines the occupant from a position where the occupant is seated. The skeleton point detecting unit 12 does not need to perform personal authentication of the occupant. For example, in the captured image, an area corresponding to the seat (hereinafter, referred to as a “seat-corresponding area”) is set in advance for each seat. The seat-corresponding area is set in advance depending on a position where the imaging device 2 is disposed and an angle of view of the imaging device 2. The skeleton point detecting unit 12 determines, depending on whether the detected skeleton coordinate points include a skeleton coordinate point included in the seat-corresponding area, a seat of an occupant of the skeleton coordinate point. As a specific example, in a case where the detected skeleton coordinate points include a skeleton coordinate point included in a seat-corresponding area corresponding to a driver's seat, the skeleton point detecting unit 12 determines that the driver is seated on the driver's seat. Then, the skeleton point detecting unit 12 determines that the skeleton coordinate point detected in the seat-corresponding area corresponding to the driver's seat is a skeleton coordinate point of the driver. For example, in a case where the detected skeleton coordinate points include a skeleton coordinate point included in a seat-corresponding area corresponding to an assistant driver's seat, the skeleton point detecting unit 12 determines that an assistant driver's seat occupant is seated on the assistant driver's seat. Then, the skeleton point detecting unit 12 determines that the skeleton coordinate point detected in the seat-corresponding area corresponding to the assistant driver's seat is a skeleton coordinate point of the assistant driver's seat occupant.

In addition, the skeleton point detecting unit 12 can also determine a gender of the occupant. The skeleton point detecting unit 12 only needs to determine the gender of the occupant using various known image processing techniques.

The skeleton point detecting unit 12 outputs information regarding the detected skeleton coordinate point (hereinafter, referred to as “skeleton coordinate point information”) to the correction amount calculating unit 13 and the skeleton point selecting unit 14. In the skeleton coordinate point information, information on a skeleton coordinate point, information indicating which part of a body the skeleton coordinate point indicates, information identifying an occupant, and information indicating a gender of the occupant are associated with each other. Specifically, the information on the skeleton coordinate point indicates coordinate values of the skeleton coordinate point on the captured image. The information identifying an occupant only needs to be, for example, information regarding a seat on which the occupant is seated.

The correction amount calculating unit 13 calculates, on the basis of the skeleton coordinate point information output from the skeleton point detecting unit 12, a correction amount in estimating a physique of the occupant. Note that the correction amount calculating unit 13 calculates the correction amount in estimating the physique of the occupant for each occupant.

In the first embodiment, the physique estimation device 1 estimates the physique of the occupant on the basis of a distance between a plurality of skeleton coordinate points (hereinafter, referred to as a “skeleton coordinate point-to-point distance”). Skeleton coordinate points, a distance between which is used for estimating the physique of the occupant, are determined in advance. More specifically, in the first embodiment, a plurality of skeleton coordinate points used for estimating the physique of the occupant (hereinafter, referred to as a “physique estimating skeleton coordinate point”) is set in advance among the plurality of skeleton coordinate points. The physique estimation device 1 estimates the physique of the occupant on the basis of a skeleton coordinate point-to-point distance between a plurality of physique estimating skeleton coordinate points.

In the first embodiment, as an example, a skeleton coordinate point indicating a right shoulder of the occupant and a skeleton coordinate point indicating a left shoulder of the occupant are defined as the physique estimating skeleton coordinate points, and the physique estimation device 1 uses a skeleton coordinate point-to-point distance between the skeleton coordinate point indicating the right shoulder of the occupant and the skeleton coordinate point indicating the left shoulder of the occupant for estimating the physique of the occupant. The skeleton coordinate point-to-point distance between the skeleton coordinate point indicating the right shoulder of the occupant and the skeleton coordinate point indicating the left shoulder of the occupant corresponds to a shoulder width of the occupant. Note that this is merely an example, and for example, in addition to the above-described skeleton coordinate points, a skeleton coordinate point indicating an elbow of the occupant may be defined as the physique estimating skeleton coordinate point, and the physique estimation device 1 may use, for example, in addition to the above-described skeleton coordinate point-to-point distance, a skeleton coordinate point-to-point distance between a skeleton coordinate point indicating the right shoulder of the occupant and a skeleton coordinate point indicating a right elbow of the occupant, or a skeleton coordinate point-to-point distance between a skeleton coordinate point indicating the left shoulder of the occupant and a skeleton coordinate point indicating a left elbow of the occupant for estimating the physique of the occupant.

A skeleton coordinate point to be used as the physique estimating skeleton coordinate point, and physique estimating skeleton coordinate points, a distance between which is used for estimating the physique of the occupant, can be appropriately set. In addition, the physique estimation device 1 may estimate the physique of the occupant using a plurality of skeleton coordinate point-to-point distances.

Note that, in the physique estimation device 1, the correction execution unit 15 calculates the skeleton coordinate point-to-point distance, and the physique estimation unit 16 estimates the physique of the occupant. Details of the correction execution unit 15 and the physique estimation unit 16 will be described later.

The correction amount calculating unit 13 calculates a correction amount for correcting the skeleton coordinate point-to-point distance used for estimating the physique of the occupant.

Here, significance of calculating the correction amount by the correction amount calculating unit 13 in the first embodiment will be described.

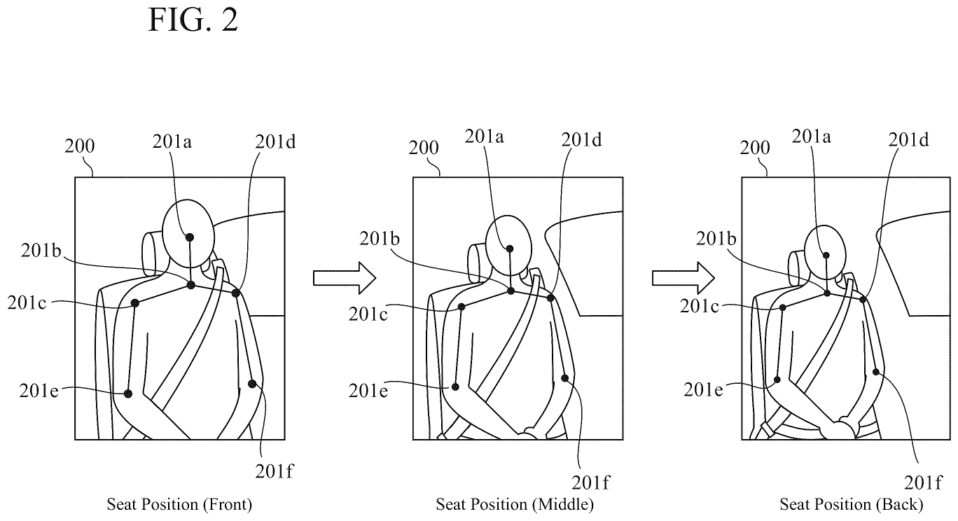

FIG. 2 is a diagram illustrating an example of a captured image 200 for describing that a skeleton coordinate point-to-point distance of an occupant seated on a seat changes due to a change in a position of the seat back and forth in the first embodiment.

Note that, for the sake of convenience, in the example of the captured image 200 illustrated in FIG. 2, only a portion where an assistant driver's seat occupant is captured is illustrated.

In FIG. 2, the left diagram illustrates an example of the captured image 200 obtained by capturing the assistant driver's seat occupant seated on the seat that has been moved to a foremost position within a movable range of the seat. In FIG. 2, the middle diagram illustrates an example of the captured image 200 obtained by capturing the assistant driver's seat occupant seated on the seat that is located at a middle position within the movable range of the seat. In FIG. 2, the right diagram illustrates an example of the captured image 200 obtained by capturing the assistant driver's seat occupant seated on the seat that has been moved to a backmost position within the movable range of the seat. That is, when a distance between the imaging device 2 and the occupant when the captured image 200 illustrated in FIG. 2 is captured is referred to as an “imaging distance”, the imaging distance when the captured image 200 illustrated in the left diagram is captured is the shortest, and the imaging distance when the captured image 200 illustrated in the right diagram is captured is the longest.

In FIG. 2, reference signs 201a, 201b, 201c, 201d, 201e, and 201f denote skeleton coordinate points of the assistant driver's seat occupant in the captured image 200.

The reference sign 201a denotes a skeleton coordinate point indicating a nose of the assistant driver's seat occupant. The reference sign 201b denotes a skeleton coordinate point indicating a neck of the assistant driver's seat occupant. The reference sign 201c denotes a skeleton coordinate point indicating a right shoulder of the assistant driver's seat occupant. The reference sign 201d denotes a skeleton coordinate point indicating a left shoulder of the assistant driver's seat occupant. The reference sign 201e denotes a skeleton coordinate point indicating a right elbow of the assistant driver's seat occupant. The reference sign 201f denotes a skeleton coordinate point indicating a left elbow of the assistant driver's seat occupant.

As illustrated in FIG. 2, the assistant driver's seat occupant is captured in a smaller size on the captured image 200 as the seat is moved further backward. In other words, as the seat is moved further backward, the position of a skeleton coordinate point on the captured image 200 changes, and as a result, a skeleton coordinate point-to-point distance is shortened on the captured image 200. In the example of FIG. 2, for example, a skeleton coordinate point-to-point distance between a skeleton coordinate point indicating the right shoulder of the assistant driver's seat occupant (see the reference sign 201c in FIG. 2) and a skeleton coordinate point indicating the right elbow (see the reference sign 201e in FIG. 2) in the captured image 200 is the longest in the captured image 200 illustrated in the left drawing, the second longest in the middle drawing, and the shortest in the right drawing.

As described above, when the position of the seat changes back and forth with respect to a traveling direction of the vehicle 100, the position of a skeleton coordinate point on the captured image changes with the front-back change of the position of the seat, and as a result, a skeleton coordinate point-to-point distance on the captured image also changes. Since the skeleton coordinate point-to-point distance on the captured image changes with the change in the position of the seat, if the change is not considered, the physique estimation device 1 may erroneously estimate the skeleton of the occupant based on the skeleton coordinate point-to-point distance. For example, the physique estimation device 1 may erroneously estimate a woman with a small physique who is seated on the seat that has been moved to a foremost position as a woman with a standard physique. In addition, for example, the physique estimation device 1 may erroneously estimate a man with a standard physique who is seated on the seat that has been moved to a backmost position as a man with a small physique.

Therefore, in the physique estimation device 1 according to the first embodiment, the correction amount calculating unit 13 calculates a correction amount for correcting a skeleton coordinate point-to-point distance depending on a front-back position of a seat with respect to a traveling direction of the vehicle 100.

As a result, in the physique estimation device 1, the physique of the occupant can be estimated in consideration of the front-back position of a seat with respect to the traveling direction of the vehicle 100, more specifically, in consideration of a fact that the skeleton coordinate point-to-point distance of an occupant in the captured image changes depending on the front-back position of the seat with respect to the traveling direction of the vehicle 100.

An example of a specific method in which the correction amount calculating unit 13 calculates a correction amount will be described.

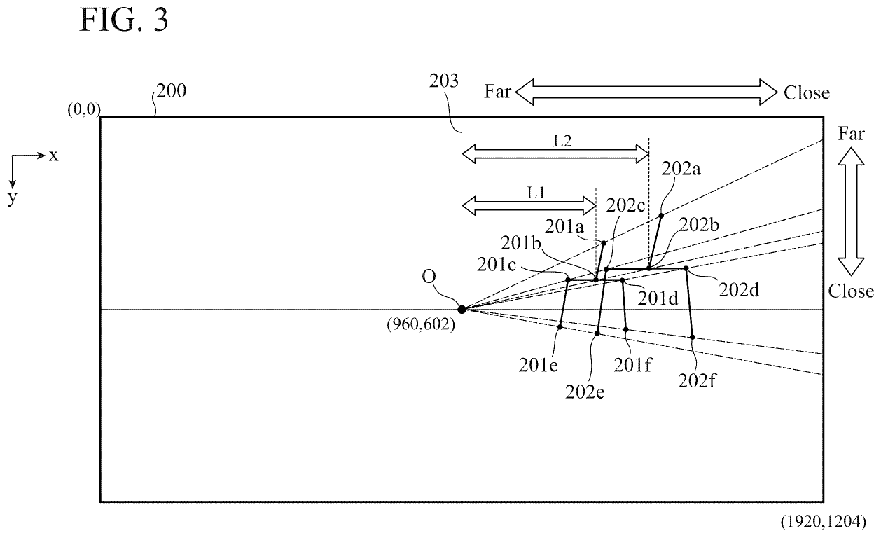

FIG. 3 is a diagram illustrating an example of the captured image 200 exemplifying a skeleton coordinate point (denoted by the reference signs 201a to 201f in FIG. 3) and a reference coordinate point (denoted by the reference signs 202a to 202f in FIG. 3) on an image in the first embodiment. An example of a method for calculating a correction amount by the correction amount calculating unit 13 in the first embodiment will be described with reference to FIG. 3.

Note that, for the sake of convenience, in the example of the captured image 200 illustrated in FIG. 3, only a skeleton coordinate point of an assistant driver's seat occupant and a reference coordinate point corresponding to the skeleton coordinate point are illustrated.

In the first embodiment, when it is assumed that a seat is at a position set in advance (hereinafter, referred to as a “reference position”) in the vehicle 100 and a person on a seat at the reference position (hereinafter, referred to as a “reference physique person”) is seated, the reference coordinate point refers to a skeleton coordinate point of the reference physique person, assumed on the captured image in which the reference physique person is captured. The reference position is a position serving as a reference in estimating a physique of an occupant of the vehicle 100. Details of the estimation of the physique of the occupant will be described later.

The reference position of the seat is appropriately set in advance within a range in which the seat is movable back and forth. In the first embodiment, as an example, it is assumed that the reference position of the seat is set at a middle position within a range in which the seat is movable back and forth.

For example, an administrator or the like sets the reference coordinate point by causing the reference physique person to be seated in a state where a seat of the vehicle 100 is set to the reference position, and performing a test of imaging the reference physique person with the imaging device 2. The reference coordinate point is set corresponding to each skeleton coordinate point detected by the skeleton point detecting unit 12. Information regarding the set reference coordinate point (hereinafter, referred to as “reference coordinate point information”) is stored in the correction amount calculating unit 13. In the reference coordinate point information, information on a reference coordinate point, information indicating which part of a body the reference coordinate point indicates, and information indicating a seat position are associated with each other. Specifically, the information on the reference coordinate point indicates coordinate values of the reference coordinate point on the captured image.

Note that a physique of the reference physique person is not limited. For example, the reference physique person may be a person with a standard physique, a person with a small physique, or a person with a large physique.

In FIG. 3, a skeleton coordinate point indicating a nose of an assistant driver's seat occupant detected by the skeleton point detecting unit 12 is denoted by the reference sign 201a, a skeleton coordinate point indicating a neck of the assistant driver's seat occupant is denoted by the reference sign 201b, a skeleton coordinate point indicating a right shoulder of the assistant driver's seat occupant is denoted by the reference sign 201c, a skeleton coordinate point indicating a left shoulder of the assistant driver's seat occupant is denoted by the reference sign 201d, a skeleton coordinate point indicating a right elbow of the assistant driver's seat occupant is denoted by the reference sign 201e, and a skeleton coordinate point indicating a left elbow of the assistant driver's seat occupant is denoted by the reference sign 201f on the captured image 200. In FIG. 3, a reference coordinate point indicating the nose is denoted by the reference sign 202a, a skeleton coordinate point indicating the neck is denoted by the reference sign 202b, a skeleton coordinate point indicating the right shoulder is denoted by the reference sign 202c, a skeleton coordinate point indicating the left shoulder is denoted by the reference sign 202d, a skeleton coordinate point indicating the right elbow is denoted by the reference sign 202e, and a skeleton coordinate point indicating the left elbow is denoted by the reference sign 202f, which are set in advance on the captured image 200.

In FIG. 3, the origin of the coordinate values on the captured image 200 is an upper left end.

As described above, when the position of the seat changes back and forth with respect to a traveling direction of the vehicle 100, the position of a skeleton coordinate point on the captured image 200 changes with the front-back movement of the seat, and as a result, a skeleton coordinate point-to-point distance on the captured image 200 also changes.

For a certain occupant, it can be said that as a skeleton coordinate point of the certain occupant detected by the skeleton point detecting unit 12 on the captured image 200 is closer to a center (hereinafter, referred to as a “center point”) of the captured image 200, the certain occupant is present at a position farther from the imaging device 2, in other words, the certain occupant is seated on a seat that has been moved backward. Conversely, it can be said that as a skeleton coordinate point of a certain occupant detected by the skeleton point detecting unit 12 on the captured image 200 is farther from the center point, the certain occupant is present at a position closer to the imaging device 2, in other words, the certain occupant is seated on a seat that has been moved forward. In FIG. 3, the center point is denoted by O. For example, for the assistant driver's seat occupant whose skeleton coordinate point illustrated in FIG. 3 is detected, the detected skeleton coordinate point of the assistant driver's seat occupant can move on a straight line connecting the center point O and each skeleton coordinate point illustrated in FIG. 3 depending on a front-back position of the assistant driver's seat.

Note that, in FIG. 3, each reference coordinate point is located on a straight line connecting the center point O and each skeleton coordinate point, but this is merely an example. The reference physique person in setting the reference coordinate point does not need to be a person of the same physique as the occupant (assistant driver's seat occupant in this case). In a case where the physique of the reference physique person is not the same as that of the occupant, each reference coordinate point is not present on a straight line connecting the center point O and each skeleton coordinate point.

The correction amount calculating unit 13 calculates a correction amount on the basis of a relative distance between the skeleton coordinate point detected by the skeleton point detecting unit 12 and the reference coordinate point.

Specifically, first, the correction amount calculating unit 13 selects one skeleton coordinate point for calculating the correction amount among the plurality of skeleton coordinate points detected by the skeleton point detecting unit 12. In the first embodiment, the skeleton coordinate point for calculating the correction amount is referred to as a “correction amount calculating skeleton coordinate point”. A part of a body indicated by a skeleton coordinate point to be used as the correction amount calculating skeleton coordinate point is set in advance and stored in the correction amount calculating unit 13. In the first embodiment, a skeleton coordinate point indicating a neck of the occupant is used as the correction amount calculating skeleton coordinate point.

Then, the correction amount calculating unit 13 calculates a horizontal distance (hereinafter, referred to as a “first distance”) from a straight line (for example, a straight line denoted by the reference sign 203 in FIG. 3) passing through a center (for example, the center point O in FIG. 3) of the captured image 200 acquired by the captured image acquiring unit 11 and parallel to a longitudinal direction of the captured image 200 to the correction amount calculating skeleton coordinate point (for example, the skeleton coordinate point denoted by the reference sign 201b in FIG. 3). In addition, the correction amount calculating unit 13 calculates a horizontal distance (hereinafter, referred to as a “second distance”) from a straight line passing through the center of the captured image 200 and parallel to the longitudinal direction of the captured image 200 to a reference coordinate point (for example, a reference coordinate point denoted by the skeleton sign 202b in FIG. 3) corresponding to the correction amount calculating skeleton coordinate point.

Specifically, the correction amount calculating unit 13 calculates the first distance according to the following equation (1). In addition, the correction amount calculating unit 13 calculates the second distance according to the following equation (2)

First distance=X coordinate of correction amount calculating skeleton coordinate point−X coordinate of center of captured image (1)

Second distance=X coordinate of reference coordinate point corresponding to correction amount calculating skeleton coordinate point−X coordinate of center of captured image (2)

Here, the correction amount calculating skeleton coordinate point is the skeleton coordinate point indicating the neck of the occupant. Therefore, in the example illustrated in FIG. 3, the correction amount calculating unit 13 calculates, as the first distance, a horizontal distance from a straight line denoted by the reference sign 203 to the skeleton coordinate point indicating the neck of the assistant driver's seat occupant denoted by the reference sign 201b in FIG. 3, and calculates, as the second distance, a horizontal distance from the straight line denoted by the reference sign 203 to the reference coordinate point indicating the neck denoted by the reference sign 202b in FIG. 3. In FIG. 3, the first distance is denoted by L₁, and the second distance is denoted by L₂.

After calculating the first distance and the second distance, the correction amount calculating unit 13 calculates the correction amount on the basis of a ratio between the first distance and the second distance.

Specifically, the correction amount calculating unit 13 calculates the correction amount according to the following equation (3).

Correction amount=(second distance)/(first distance) (3)

As described above, the correction amount calculating unit 13 selects the correction amount calculation skeleton coordinate point on the basis of the skeleton coordinate point information output from the skeleton point detecting unit 12, calculates the first distance that is a horizontal distance from a straight line passing through the center of the captured image and parallel to the longitudinal direction of the captured image to the correction amount calculating skeleton coordinate point and the second distance that is a horizontal distance from the straight line to a reference coordinate point on the captured image corresponding to the correction amount calculating skeleton coordinate point, and calculates the correction amount on the basis of a ratio between the calculated first distance and second distance.

Note that, here, the skeleton coordinate point indicating the neck of the occupant is used as the correction amount calculating skeleton coordinate point, but this is merely an example. The correction amount calculating skeleton coordinate point can be a skeleton coordinate point according to a need among the plurality of skeleton coordinate points detected by the skeleton point detecting unit 12. Note that the correction amount calculating skeleton coordinate point is preferably a skeleton coordinate point indicating a body part with less movement, such as a neck. By using the skeleton coordinate point indicating a part of a body with little movement as the correction amount calculating skeleton coordinate point, the correction amount calculated on the basis of the correction amount calculating skeleton coordinate point can be a stable value. As a result, the physique estimation device 1 can obtain a stable estimation result of the physique of the occupant.

The correction amount calculating unit 13 outputs information regarding the calculated correction amount (hereinafter, referred to as “correction amount information”) to the correction execution unit 15. In the correction amount information, for example, information identifying an occupant is associated with the correction amount for each occupant. The information identifying an occupant only needs to be, for example, information regarding a seat on which the occupant is seated.

The skeleton point selecting unit 14 selects a plurality of physique estimating skeleton coordinate points from among the plurality of skeleton coordinate points detected by the skeleton point detecting unit 12 on the basis of the skeleton coordinate point information output from the skeleton point detecting unit 12. The skeleton point selecting unit 14 stores information on which skeleton coordinate point is used as the physique estimating skeleton coordinate point. Note that the skeleton point selecting unit 14 selects a physique determining skeleton coordinate point for each occupant.

In the first embodiment, as an example, since the skeleton coordinate point of the shoulder of the occupant is used as the physique estimating skeleton coordinate point, the skeleton point selecting unit 14 selects the skeleton coordinate point of the shoulder of the occupant as the physique estimating skeleton coordinate point from among the plurality of skeleton coordinate points detected by the skeleton point detecting unit 12. For example, in the captured image 200 as illustrated in FIG. 2, the skeleton point selecting unit 14 selects a skeleton coordinate point indicating a right shoulder of the assistant driver's seat occupant denoted by the reference sign 201c and a skeleton coordinate point indicating a left shoulder of the assistant driver's seat occupant denoted by the reference sign 201d as the physique estimating skeleton coordinate point used for estimating the physique of the assistant driver's seat occupant.

The skeleton point selecting unit 14 outputs information regarding the selected physique estimating skeleton coordinate point (hereinafter, referred to as “physique estimating skeleton coordinate point information”) to the correction execution unit 15. For example, in the physique estimating skeleton coordinate point information, information identifying an occupant, information on the physique estimating skeleton coordinate point, information indicating which part of the body the physique estimating skeleton coordinate point indicates, and information indicating a gender of the occupant are associated with each other for each occupant. Specifically, the information identifying an occupant is information indicating a seat on which the occupant is seated. Specifically, the information on the physique estimating skeleton coordinate point indicates coordinate values of the physique estimating skeleton coordinate point on the captured image. The skeleton point selecting unit 14 can determine information included in the skeleton physique estimating skeleton coordinate point information as described above from the skeleton coordinate point information.

The correction execution unit 15 calculates a skeleton coordinate point-to-point distance between the plurality of physique estimating skeleton coordinate points selected by the skeleton point selecting unit 14 on the basis of the physique estimating skeleton coordinate point information output from the skeleton point selecting unit 14. Then, the correction execution unit 15 corrects the calculated skeleton coordinate point-to-point distance using the correction amount calculated by the correction amount calculating unit 13 on the basis of the correction amount information output from the correction amount calculating unit 13. Note that the correction execution unit 15 calculates the skeleton coordinate point-to-point distance and corrects the calculated skeleton coordinate point-to-point distance for each occupant. The correction execution unit 15 uses the correction amount associated with the occupant in correcting the skeleton coordinate point-to-point distance.

The correction execution unit 15 corrects the skeleton coordinate point-to-point distance according to the following equation (4).

Corrected skeleton coordinate point-to-point distance=skeleton coordinate point-to-point distance×correction amount (4)

Specifically, the correction execution unit 15 calculates a skeleton coordinate point-to-point distance between the skeleton coordinate point indicating the right shoulder and the skeleton coordinate point indicating the left shoulder, and corrects the calculated skeleton coordinate point-to-point distance using the correction amount for each occupant.

The skeleton coordinate point-to-point distance corrected by the correction execution unit 15 is a skeleton coordinate point-to-point distance of the occupant on the captured image obtained by capturing the occupant, assumed when the occupant is seated on a seat at the reference position.

The correction execution unit 15 outputs information regarding the corrected skeleton coordinate point-to-point distance (hereinafter, referred to as “corrected distance information”) to the physique estimation unit 16. For example, in the corrected distance information, information identifying an occupant, information on a corrected skeleton coordinate point-to-point distance of the occupant, and information indicating a gender of the occupant are associated with each occupant for each occupant. Specifically, the information identifying an occupant is information indicating a seat on which the occupant is seated. The correction execution unit 15 only needs to acquire the information identifying an occupant and the information indicating a gender of the occupant from the physique estimating skeleton coordinate point information.

The physique estimation unit 16 estimates a physique of the occupant on the basis of the corrected distance information output from the correction execution unit 15. More specifically, the physique estimation unit 16 estimates the physique of the occupant on the basis of the skeleton coordinate point-to-point distance calculated by the correction execution unit 15 on the basis of the physique estimating skeleton coordinate point information and corrected using the correction amount based on the correction amount information calculated by the correction amount calculating unit 13. Note that the physique estimation unit 16 estimates the physique of the occupant for each occupant.

In the first embodiment, as described above, as an example, the physique of the occupant is defined as any one of an “infant”, a “small man”, a “small woman”, a “standard man”, a “standard woman”, a “large man”, and a “large woman”.

For example, the physique estimation unit 16 estimates the physique of the occupant by obtaining information regarding the physique of the occupant using a trained model in machine learning (hereinafter, referred to as a “second machine learning model”) that receives, as an input, the skeleton coordinate point-to-point distance and outputs information regarding the physique of the occupant. The information regarding the physique may be, for example, a numerical value indicating the physique, such as “0”, “1”, “2”, or “3”, or may be an index (hereinafter, referred to as a “physique index”) indicating a magnitude degree of the physique. Regarding the numerical value indicating the physique, a physique indicated by a numerical value is determined in advance. For example, a physique indicated by a numerical value is determined, such as “00: infant”, “11: small man”, “12: small woman”, “21: standard man”, “22: standard woman”, “31: large man”, or “32: large woman”.

The second machine learning model performs learning in such a way as to receive, as an input, a skeleton coordinate point-to-point distance of a person seated on a seat at the reference position on a captured image obtained by capturing the person and to output information regarding the physique of the person seated on the seat at the reference position.

The physique estimation unit 16 estimates the physique of the occupant on the basis of information regarding the physique of the occupant obtained on the basis of the second machine learning model. For example, when the information regarding the physique of the occupant is a numerical value indicating the physique as described above, the physique estimation unit 16 estimates a physique determined in advance depending on the numerical value as the physique of the occupant. In addition, for example, when the information regarding the physique of the occupant is a physique index, the physique estimation unit 16 estimates the physique depending on the index. Specifically, information (hereinafter, referred to as “physique definition information”) in which association is made in such a way to indicate what physique index corresponds to any one of an “infant”, a “small man”, a “small woman”, a “standard man”, a “standard woman”, a “large man”, and a “large woman” as a physique is generated in advance and stored in the physique estimation unit 16. The physique estimation unit 16 estimates the physique of the occupant by referring to the physique definition information.

Note that this is merely an example, and the physique estimation unit 16 may estimate the physique of the occupant by another method. For example, the physique estimation unit 16 may estimate the physique of the occupant by collating, for each gender, information (hereinafter, referred to as “physique estimation information”) in which information on a skeleton coordinate point-to-point distance of a person seated on a seat at the reference position is associated with the physique of the occupant seated on the seat at the reference position, estimated from the skeleton coordinate point-to-point distance, with the corrected distance information output from the correction execution unit 15. The physique estimation information is set in advance and stored in the physique estimation unit 16.

The physique estimation unit 16 outputs the physique estimation result to the estimation result outputting unit 17.

In the physique estimation result, information identifying an occupant is associated with information indicating the physique of the occupant for each occupant. Specifically, the information identifying an occupant is information indicating a seat on which the occupant is seated. The physique estimation unit 16 only needs to acquire information identifying an occupant from the corrected distance information output from the correction execution unit 15.

The estimation result outputting unit 17 outputs the physique estimation result output from the physique estimation unit 16 to, for example, an airbag control device, a notification device, or a display device.

The physique estimation device 1 does not have to include the estimation result outputting unit 17, and the physique estimation unit 16 may have the function of the estimation result outputting unit 17.

An operation of the physique estimation device 1 according to the first embodiment will be described.

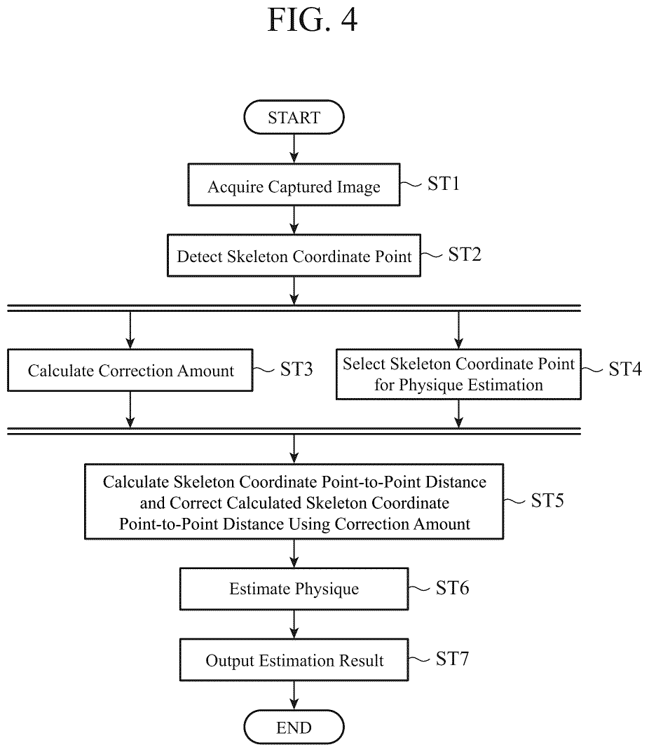

FIG. 4 is a flowchart for describing the operation of the physique estimation device 1 according to the first embodiment.

The captured image acquiring unit 11 acquires a captured image in which an occupant of the vehicle 100 is captured by the imaging device 2 (step ST1).

The captured image acquiring unit 11 outputs the acquired captured image to the skeleton point detecting unit 12.

The skeleton point detecting unit 12 detects a skeleton coordinate point of the occupant indicating a part of a body of the occupant on the basis of the captured image acquired by the captured image acquiring unit 11 in step ST1 (step ST2).

When detecting the skeleton coordinate point, the skeleton point detecting unit 12 also detects which occupant's skeleton coordinate point the detected skeleton coordinate point is and a gender of the occupant.

The skeleton point detecting unit 12 outputs the skeleton coordinate point information to the correction amount calculating unit 13 and the skeleton point selecting unit 14.

The correction amount calculating unit 13 calculates, on the basis of the skeleton coordinate point information output from the skeleton point detecting unit 12 in step ST2, a correction amount in estimating a physique of the occupant (step ST3).

The correction amount calculating unit 13 outputs the correction amount information to the correction execution unit 15.

The skeleton point selecting unit 14 selects a plurality of physique estimating skeleton coordinate points from among the plurality of skeleton coordinate points detected by the skeleton point detecting unit 12 on the basis of the skeleton coordinate point information output from the skeleton point detecting unit 12 in step ST2 (step ST4).

The skeleton point selecting unit 14 outputs the physique estimating skeleton coordinate point information to the correction execution unit 15.

The correction execution unit 15 calculates a skeleton coordinate point-to-point distance between the plurality of physique estimating skeleton coordinate points selected by the skeleton point selecting unit 14 on the basis of the physique estimating skeleton coordinate point information output from the skeleton point selecting unit 14 in step ST4. Then, the correction execution unit 15 corrects the calculated skeleton coordinate point-to-point distance using the correction amount calculated by the correction amount calculating unit 13 on the basis of the correction amount information output from the correction amount calculating unit 13 in step ST3 (step ST5).

The correction execution unit 15 outputs the corrected distance information to the physique estimation unit 16.

The physique estimation unit 16 estimates a physique of the occupant on the basis of the corrected distance information output from the correction execution unit 15 in step ST5 (step ST6).

The physique estimation unit 16 outputs the physique estimation result to the estimation result outputting unit 17.

The estimation result outputting unit 17 outputs the physique estimation result output from the physique estimation unit 16 in step ST6 to, for example, an airbag control device, a notification device, or a display device (step ST7).

Note that, regarding the operation of the physique estimation device 1 described with reference to FIG. 4, in the flowchart of FIG. 4, the process in step ST3 and the process in step ST4 are performed in parallel, but this is merely an example. After the process in step ST3, the process in step ST4 may be performed, or after the process in step ST4, the process in step ST3 may be performed. After the process in step ST2 is performed and before the process in step ST5 is performed, the process in step ST3 and the process in step ST4 only need to be completed.

As described above, the physique estimation device 1 according to the first embodiment calculates, on the basis of the skeleton coordinate point information regarding the plurality of skeleton coordinate points detected on the basis of a captured image in which an occupant of the vehicle 100 is captured, the correction amount on the basis of a ratio between the first distance that is a horizontal distance from a straight line passing through the center of the captured image and parallel to the longitudinal direction of the captured image to the correction amount calculating skeleton coordinate point and the second distance that is a horizontal distance from the straight line to a reference coordinate point on the captured image corresponding to the correction amount calculating skeleton coordinate point. The physique estimation device 1 estimates the physique of the occupant on the basis of a plurality of skeleton coordinate points of the occupant, more specifically, on the basis of information on a plurality of physique estimating skeleton coordinate points of the occupant and the calculated correction amount. Specifically, the physique estimation device 1 calculates a skeleton coordinate point-to-point distance between a plurality of physique estimating skeleton coordinate points, corrects the calculated skeleton coordinate point-to-point distance using the calculated correction amount, and estimates the physique of the occupant from the corrected skeleton coordinate point-to-point distance.

As described above, in the vehicle 100, a seat on which the occupant is seated can be moved back and forth with respect to a traveling direction of the vehicle. In the vehicle 100, when the seat is moved back and forth, the occupant is captured in a large size or in a small size on a captured image along with the movement. Therefore, in order to prevent erroneous estimation of the physique of the occupant that can be captured in a large size or in a small size on the captured image, it is necessary to consider a front-back position of the seat on which the occupant is seated, in other words, a distance from the imaging device 2 to the occupant.

Here, in general, examples of a method for measuring a distance to an object using an imaging device include the following two methods.
Method for calculating a distance from comparison between a width of an object on a captured image captured by the imaging device and an actual width of the object
A method for calculating a distance from comparison between a width of an object on a captured image captured by the imaging device and a width of the object on a captured image in which the object is captured by the captured image while the object is placed at a reference position set in advance.

However, the above-described two methods are based on a premise that a width of an object whose distance from the imaging device is to be measured is known in advance.

Therefore, in estimating the physique of the occupant of the vehicle 100 whose physique is unknown in advance, the distance from the imaging device 2 to the occupant cannot be estimated using the above-described two methods. As a result, it is not possible to estimate the physique of the occupant in consideration of a front-back position of a seat on which the occupant is seated using the above-described two methods.

Meanwhile, the physique estimation device 1 according to the first embodiment calculates the correction amount on the basis of a ratio between the first distance that is a horizontal distance from a straight line passing through the center of the captured image and parallel to the longitudinal direction of the captured image to the correction amount calculating skeleton coordinate point and the second distance that is a horizontal distance from the straight line to a reference coordinate point on the captured image corresponding to the correction amount calculating skeleton coordinate point. Then, the physique estimation device 1 corrects the skeleton coordinate point-to-point distance using the correction amount, and estimates the physique of the occupant from the corrected skeleton coordinate point-to-point distance.

As a result, the physique estimation device 1 can calculate the skeleton coordinate point-to-point distance of the occupant on the captured image in a case where it is assumed that the occupant is seated on a seat at the reference position even when it is unknown in advance what type of physique the occupant has. Therefore, the physique estimation device 1 can improve accuracy of estimating the physique of the occupant of the vehicle 100 when a seat on which the occupant is seated is moved back and forth with respect to a traveling direction of the vehicle 100. In addition, by estimating the physique from the corrected skeleton coordinate point-to-point distance, the physique estimation device 1 can accurately estimate the physique of the occupant using an algorithm for estimating the physique of the occupant when the occupant is seated on the seat at the reference position regardless of an actually set front-back position of a seat on which the occupant is seated.

In the first embodiment described above, the correction execution unit 15 calculates a skeleton coordinate point-to-point distance between a plurality of physique estimating skeleton coordinate points, and then corrects the calculated skeleton coordinate point-to-point distance using the correction amount. However, this is merely an example. For example, the correction execution unit 15 may first correct the coordinate values on the captured image of the physique estimating skeleton coordinate point selected by the skeleton point selecting unit 14 using the correction amount calculated by the correction amount calculating unit 13, and calculate a skeleton coordinate point-to-point distance on the basis of the corrected coordinate values of the plurality of physique estimating skeleton coordinate points. The correction execution unit 15 outputs the corrected distance information to the physique estimation unit 16 using the calculated skeleton coordinate point-to-point distance as the corrected skeleton coordinate point-to-point distance.

Note that, in this case, in the operation of the physique estimation device 1 described with reference to the flowchart of FIG. 4, in step ST5, the correction execution unit 15 corrects the coordinate values of the physique estimating skeleton coordinate point using the correction amount calculated by the correction amount calculating unit 13, and then calculates the skeleton coordinate point-to-point distance on the basis of the corrected coordinate values of the physique estimating skeleton coordinate point.

In addition, in the first embodiment, one correction amount calculating skeleton coordinate point is used, and the correction amount calculating unit 13 selects one correction amount calculating skeleton coordinate point from among the plurality of skeleton coordinate points detected by the skeleton point detecting unit 12. However, this is merely an example. For example, there may be a plurality of correction amount calculating skeleton coordinate points.

In this case, for example, the correction amount calculating unit 13 calculates a provisional correction amount (hereinafter, referred to as a “provisional correction amount”) on the basis of a ratio between the first distance and the second distance for each correction amount calculating skeleton coordinate point. Then, the correction amount calculating unit 13 uses an average of the provisional correction amounts corresponding to the correction amount calculating skeleton coordinate points as the correction amount.

The correction amount calculating unit 13 calculates the provisional correction amount on the basis of a ratio between the first distance and the second distance for the plurality of correction amount calculating skeleton coordinate points, and calculates the correction amount from the calculated provisional correction amount, whereby the physique estimation device 1 can obtain a more accurate correction amount. As a result, the physique estimation device 1 can further improve accuracy of estimating the physique of the occupant of the vehicle 100 when a seat on which the occupant is seated is moved back and forth with respect to a traveling direction of the vehicle.

In addition, in the first embodiment, all the plurality of skeleton coordinate points detected by the skeleton point detecting unit 12 may be used as the physique estimating skeleton coordinate points.

In this case, the skeleton point detecting unit 12 outputs the skeleton coordinate point information to the correction execution unit 15. For example, the correction execution unit 15 calculates a skeleton coordinate point-to-point distance between the plurality of skeleton coordinate points detected by the skeleton point detecting unit 12 on the basis of the skeleton coordinate point information. Then, the correction execution unit 15 corrects the calculated skeleton coordinate point-to-point distance using the correction amount calculated by the correction amount calculating unit 13.

For example, the correction execution unit 15 may first correct, on the basis of the skeleton coordinate point information, the coordinate values of the plurality of skeleton coordinate points detected by the skeleton point detecting unit 12 using the correction amount calculated by the correction amount calculating unit 13, and calculate a skeleton coordinate point-to-point distance on the basis of the corrected coordinate values of the plurality of skeleton coordinate points.

In this case, the physique estimation device 1 can have a configuration not including the skeleton point selecting unit 14. In a case where the physique estimation device 1 does not include the skeleton point selecting unit 14, the process in step ST4 can be omitted in the flowchart of FIG. 4 used to describe the operation of the physique estimation device 1.

In addition, in the first embodiment described above, the physique estimation device 1 estimates physiques of the driver and the assistant driver's seat occupant of the vehicle 100, but this is merely an example. The physique estimation device 1 may estimate the physique of either the driver or the assistant driver's seat occupant. The physique estimation device 1 can also estimate a physique of an occupant on a back seat.

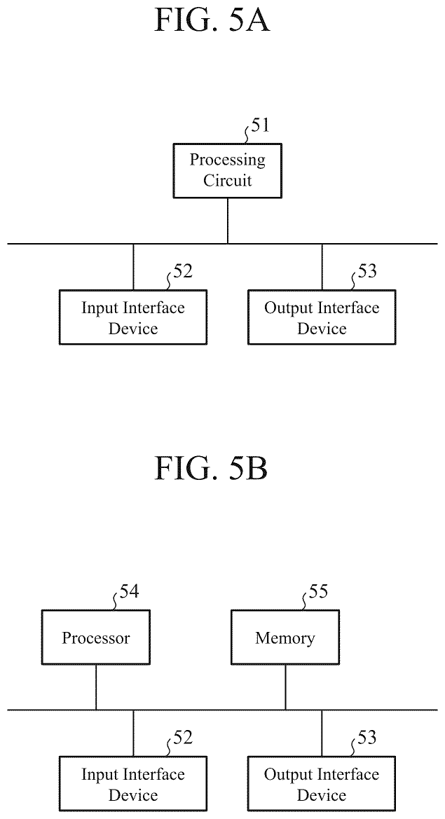

FIGS. 5A and 5B are each a diagram illustrating an example of a hardware configuration of the physique estimation device 1 according to the first embodiment.

In the first embodiment, functions of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 are implemented by a processing circuit 51. That is, the physique estimation device 1 includes the processing circuit 51 for calculating a correction amount used in estimating a physique of an occupant of the vehicle 100 on the basis of a captured image in which the occupant is captured, and performing control to estimate the physique of the occupant from a skeleton coordinate point-to-point distance calculated on the basis of the correction amount.

The processing circuit 51 may be dedicated hardware as illustrated in FIG. 5A, or a processor 54 that executes a program stored in a memory as illustrated in FIG. 5B.

In a case where the processing circuit 51 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 51.

In a case where the processing circuit is the processor 54, the functions of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 are implemented by software, firmware, or a combination of software and firmware. Software or firmware is described as a program and stored in a memory 55. The processor 54 executes the functions of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 by reading and executing the program stored in the memory 55. That is, the physique estimation device 1 includes the memory 55 for storing a program that causes steps ST1 to ST7 of FIG. 4 described above to be executed as a result when the program is executed by the processor 54. In addition, it can be said that the program stored in the memory 55 causes a computer to execute procedures or methods of processing performed by the captured image acquiring unit 11, the skeleton point detecting unit 12, the correction amount calculating unit 13, the skeleton point selecting unit 14, the correction execution unit 15, the physique estimation unit 16, and the estimation result outputting unit 17. Here, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disc, a compact disc, a mini disc, or a digital versatile disc (DVD) corresponds to the memory 55.

Note that some of the functions of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 may be implemented by dedicated hardware, and some of the functions may be implemented by software or firmware. For example, the function of the captured image acquiring unit 11 can be implemented by the processing circuit 51 as dedicated hardware, and the functions of the skeleton point detecting unit 12, the correction amount calculating unit 13, the skeleton point selecting unit 14, the correction execution unit 15, the physique estimation unit 16, and the estimation result outputting unit 17 can be implemented by the processor 54 reading and executing a program stored in the memory 55.

The physique estimation device 1 includes an input interface device 52 and an output interface device 53 that perform wired communication or wireless communication with a device such as the imaging device 2, an airbag control device, a notification device, or a display device.

In the first embodiment described above, the physique estimation device 1 is an in-vehicle device mounted on the vehicle 100, and the captured image acquiring unit 11, the skeleton point detecting unit 12, the correction amount calculating unit 13, the skeleton point selecting unit 14, the correction execution unit 15, the physique estimation unit 16, and the estimation result outputting unit 17 are included in the physique estimation device 1.

It is not limited to this, and some of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 may be mounted on an in-vehicle device of a vehicle, and the others may be included in a server connected to the in-vehicle device via a network. In this manner, the in-vehicle device and the server may constitute a physique estimation system.

In addition, all of the captured image acquiring unit 11, the skeleton point detecting unit 12, the correction amount calculating unit 13, the skeleton point selecting unit 14, the correction execution unit 15, the physique estimation unit 16, and the estimation result outputting unit 17 may be included in the server.

As described above, according to the first embodiment, the physique estimation device 1 includes: the captured image acquiring unit 11 that acquires a captured image in which an occupant of a vehicle 100 is captured by an imaging device 2 having an optical axis parallel to a moving direction of a seat of the vehicle 100 movable back and forth with respect to a traveling direction of the vehicle 100; the skeleton point detecting unit 12 that detects a plurality of skeleton coordinate points of the occupant indicating parts of a body of the occupant on the captured image on the basis of the captured image acquired by the captured image acquiring unit 11; the correction amount calculating unit 13 that calculates, on the basis of information regarding the plurality of skeleton coordinate points detected by the skeleton point detecting unit 12, a correction amount on the basis of a ratio between a first distance that is a horizontal distance from a straight line passing through a center of the captured image acquired by the captured image acquiring unit 11 and parallel to a longitudinal direction of the captured image to a correction amount calculating skeleton coordinate point among the plurality of skeleton coordinate points detected by the skeleton point detecting unit 12 and a second distance that is a horizontal distance from the straight line to a reference coordinate point on the captured image corresponding to the correction amount calculating skeleton coordinate point, set by assuming the correction amount calculating skeleton coordinate point in a case where the seat is at a set reference position; and the physique estimation unit 16 that estimates a physique of the occupant on the basis of the information regarding the plurality of skeleton coordinate points detected by the skeleton point detecting unit 12 and the correction amount calculated by the correction amount calculating unit 13. Therefore, the physique estimation device 1 can improve accuracy of estimating the physique of the occupant of the vehicle 100 when a seat on which the occupant is seated is moved back and forth with respect to a traveling direction of the vehicle.

More specifically, the physique estimation device 1 includes the correction execution unit 15 that calculates a skeleton coordinate point-to-point distance between the plurality of skeleton coordinate points detected by the skeleton point detecting unit 12 and corrects the calculated skeleton coordinate point-to-point distance using the correction amount calculated by the correction amount calculating unit 13, and the physique estimation unit 16 estimates the physique of the occupant from the skeleton coordinate point-to-point distance corrected by the correction execution unit 15. Therefore, the physique estimation device 1 can improve accuracy of estimating the physique of the occupant of the vehicle 100 when a seat on which the occupant is seated is moved back and forth with respect to a traveling direction of the vehicle.

In addition, the physique estimation device 1 includes the correction execution unit 15 that corrects coordinate values of the plurality of skeleton coordinate points detected by the skeleton point detecting unit 12 using the correction amount calculated by the correction amount calculating unit 13 and calculates a skeleton coordinate point-to-point distance between the plurality of skeleton coordinate points on the basis of the corrected coordinate values of the plurality of skeleton coordinate points, and the physique estimation unit 16 estimates the physique of the occupant from the skeleton coordinate point-to-point distance calculated by the correction execution unit 15. Therefore, the physique estimation device 1 can improve accuracy of estimating the physique of the occupant of the vehicle 100 when a seat on which the occupant is seated is moved back and forth with respect to a traveling direction of the vehicle.

Note that, in the present disclosure, any component in the embodiment can be modified, or any component in the embodiment can be omitted.

### INDUSTRIAL APPLICABILITY

The physique estimation device according to the present disclosure estimates a physique of an occupant of a vehicle in consideration of a fact that a seat on which the occupant is seated is moved back and forth with respect to a traveling direction of the vehicle, and therefore can improve accuracy of estimating the physique of the occupant when the seat on which the occupant of the vehicle is seated is moved back and forth with respect to the traveling direction of the vehicle.

### REFERENCE SIGNS LIST

1: physique estimation device, 11: captured image acquiring unit, 12: skeleton point detecting unit, 13: correction amount calculating unit, 14: skeleton point selecting unit, 15: correction execution unit, 16: physique estimation unit, 17: estimation result outputting unit, 2: imaging device, 100: vehicle, 51: processing circuit, 52: input interface device, 53: output interface device, 54: processor, 55: memory

1. A physique estimation device comprising processing circuitry
to acquire a captured image in which an occupant of a vehicle is captured by an imaging device having an optical axis parallel to a moving direction of a seat of the vehicle, the seat being movable back and forth with respect to a traveling direction of the vehicle,
to detect a plurality of skeleton coordinate points of the occupant indicating parts of a body of the occupant on the captured image on a basis of the captured image,
to calculate, on a basis of information regarding the plurality of skeleton coordinate points, a correction amount on a basis of a ratio between a first distance and a second distance, the first distance being a horizontal distance from a straight line passing through a center of the captured image and parallel to a longitudinal direction of the captured image to at least one correction amount calculating skeleton coordinate point among the plurality of skeleton coordinate points and the second distance being a horizontal distance from the straight line to a reference coordinate point on the captured image corresponding to the at least one correction amount calculating skeleton coordinate point, the reference coordinate point being set by assuming the at least one correction amount calculating skeleton coordinate point in a case where the seat is at a set reference position, and
to estimate a physique of the occupant on a basis of the information regarding the plurality of skeleton coordinate points and the correction amount.

2. The physique estimation device according to claim 1, wherein the processing circuitry further performs to calculate a skeleton coordinate point-to-point distance between the plurality of skeleton coordinate points and performs correction of the skeleton coordinate point-to-point distance calculated using the correction amount, and
to estimate the physique of the occupant from the skeleton coordinate point-to-point distance after the correction.

3. The physique estimation device according to claim 1, wherein the processing circuitry further performs correction of coordinate values of the plurality of skeleton coordinate points using the correction amount and to calculate a skeleton coordinate point-to-point distance between the plurality of skeleton coordinate points on a basis of the coordinate values of the plurality of skeleton coordinate points being corrected, wherein
the processing circuitry estimates the physique of the occupant from the skeleton coordinate point-to-point distance after the correction.

4. The physique estimation device according to claim 1, wherein
the at least one correction amount calculating skeleton coordinate point is the skeleton coordinate point indicating a neck of the occupant.

5. The physique estimation device according to claim 1, wherein
the at least one correction amount calculating skeleton coordinate point includes a plurality of correction amount calculating skeleton coordinate points, and
the processing circuitry calculates each of a plurality of provisional correction amounts on a basis of a ratio between the first distance and the second distance for each of the plurality of correction amount calculating skeleton coordinate points, and uses an average of the plurality of provisional correction amounts respectively corresponding to the plurality of correction amount calculating skeleton coordinate points as the correction amount.

6. The physique estimation device according to claim 2, the processing circuitry performs selection of a plurality of physique estimating skeleton coordinate points used for estimating the physique of the occupant from among the plurality of skeleton coordinate points, and
the correction execution unit calculates the skeleton coordinate point-to-point distance between the plurality of physique estimating skeleton coordinate points selected by the selection.

7. The physique estimation device according to claim 3, wherein the processing circuitry performs selection of a plurality of physique estimating skeleton coordinate points to be used for estimating the physique of the occupant from among the plurality of skeleton coordinate points, and
corrects coordinate values of the plurality of physique estimating skeleton coordinate points selected by the selection using the correction amount, and calculates the skeleton coordinate point-to-point distance between the plurality of physique estimating skeleton coordinate points on a basis of the corrected coordinate values of the plurality of physique estimating skeleton coordinate points.

8. A physique estimation method comprising:
acquiring a captured image in which an occupant of a vehicle is captured by an imaging device having an optical axis parallel to a moving direction of a seat of the vehicle, the seat being movable back and forth with respect to a traveling direction of the vehicle:
detecting a plurality of skeleton coordinate points of the occupant indicating parts of a body of the occupant on the captured image on a basis of the captured image;
calculating on a basis of information regarding the plurality of skeleton coordinate points, a correction amount on a basis of a ratio between a first distance and a second distance, the first distance being a horizontal distance from a straight line passing through a center of the captured image and parallel to a longitudinal direction of the captured image to at least one correction amount calculating skeleton coordinate point among the plurality of skeleton coordinate points and the second distance being a horizontal distance from the straight line to a reference coordinate point on the captured image corresponding to the at least one correction amount calculating skeleton coordinate point, the reference coordinate point being set by assuming the at least one correction amount calculating skeleton coordinate point in a case where the seat is at a set reference position; and
estimating a physique of the occupant on a basis of the information regarding the plurality of skeleton coordinate points and the correction amount.
